(19) United States
(12) Patent Application Publication
(10) Pub. No.: US 2008/0052437 A1
(43) Pub. Date: Feb. 28, 2008

(54) Hot Plug Power Policy for Modular Chassis

(75) Inventors: John S. Loffink, Austin, TX (US); Stephen D. Cochran, Cedar Park, TX (US)

Correspondence Address: HAYNES AND BOONE, LLP, 901 Main Street, Suite 3100, Dallas, TX, 75202, US

(73) Assignee: Dell Products L.P., Round Rock, TX (US)

(21) Appl. No.: 11/467,714

(22) Filed: Aug. 28, 2006

(51) Int. Cl. G06F 13/00; G06F 1/00

(52) U.S. Cl. 710/302; 713/300

(57) ABSTRACT

For distributing available power between a plurality of cards hot pluggable into chassis slots, a power policy, which defines rules and conditions for assuredly distributing the available power to selected ones of the plurality of cards, is configured. The selected ones, each of which is assured to receive power when hot plugged, are selectable to include any card of the plurality of cards. When any one of the plurality of cards is hot plugged into one of the slots, the power policy is triggered to assuredly distribute the available power to the selected ones that are hot plugged, or activate an alarm if the any one card that is hot plugged is excluded from the selected ones. The power policy is modifiable in response to a change in the rules and conditions.

### BACKGROUND

The present disclosure relates generally to information handling systems, and more particularly to tools and techniques for improved power allocation in an information handling system (IHS).

As the value and use of information continues to increase, individuals and businesses seek additional ways to process and store information. One option is an IHS. An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, entertainment, enterprise data storage, or global communications. In addition, IHSs may include a variety of hardware and software components that may be configured to process, store, and communicate information and may include one or more computer systems, data storage systems, and networking systems.

In IHSs that are configured as servers, each component or module included in the server is typically hot pluggable. That is, any module may be inserted into an available slot of the server chassis while the server is on-line. The insertion or the removal of a component while the server is on-line does not disrupt the operation of the other components or modules of the server. Some modules may be shared across blade servers. The availability of the shared modules may affect the overall availability of the server more than the availability of non-shared modules. Thus, it would be desirable to ensure that these shared modules be powered on when inserted into one of the shared slots. Because capacity of the one or more power supplies providing power to the server components is limited, it would be desirable to improve availability by reserving power for the shared modules, which would however, reduce the power available to other modules of the server.

However, many preset or factory set power allocation tools and techniques (may also be referred to as power sharing algorithms, power policies implemented in a power controller, or a power distributor) often reserve power for shared modules such as input/output (I/O) modules, which may or may not be actually used in a particular server configuration. Reserving the power in configurations where I/O modules may not be used in a particular configuration may unnecessarily prohibit support for server applications that demand high performance, and high power. For example, a preset power allocation technique may be used to prioritize I/O fabric switch cards, thereby automatically reserving power for these cards. Worst case scenarios for module power consumption are often used in spare power calculations, even though the actual server configuration may use a lower power I/O fabric switch or may use pass through cards consuming less power. The over-provisioning of power for the I/O fabric switch cards may potentially limit a blade server or any other component from receiving power when hot plugged. That is, many preset power allocation schemes may not assure server components such as a blade server that they would receive power when hot plugged. Thus, many traditional power allocation tools and techniques may degrade user experience.

### SUMMARY

Applicants recognize an existing need for improving allocating power to modules that are hot pluggable into a server, the allocation of power occurring in accordance with a power policy that is customizable for a configuration of the server, absent the disadvantages found in the prior techniques discussed above.

The foregoing need is addressed by the teachings of the present disclosure, which relates to allocating power to modules that are hot pluggable into a server. According to one embodiment, in a method and system for distributing available power between a plurality of cards hot pluggable into chassis slots, a power policy, which defines rules and conditions for assuredly distributing the available power to selected ones of the plurality of cards, is configured. The selected ones, each of which is assured to receive power when hot plugged, are selectable to include any card of the plurality of cards. When any one of the plurality of cards is hot plugged into one of the slots, the power policy is triggered to assuredly distribute the available power to the selected ones that are hot plugged, or activate an alarm if the any one card that is hot plugged is excluded from the selected ones. The power policy is modifiable in response to a change in the rules and conditions.

In one aspect, a server includes a plurality of cards that are hot pluggable into the slots of a chassis. A power supply provides power to the plurality of cards via a backplane. The backplane also enables communication between the plurality of cards. One of the plurality of cards is a chassis controller that is operable to control the power by assuredly providing the power to selected ones of the plurality of cards. The selected ones of the plurality of cards are selectable to include any card of the plurality of cards. Any one of the selected ones is assured to receive the power when hot plugged into one of the slots.

### BRIEF DESCRIPTION OF THE DRAWINGS

FIG. 1 illustrates a block diagram of an IHS, according to an embodiment.

FIG. 2A illustrates a block diagram of a server system, according to an embodiment.

FIG. 2B illustrates a rear view of a server chassis used for mounting components of a server system described with reference to FIG. 2A, according to an embodiment.

FIG. 3A illustrates a block diagram to show additional details of a chassis controller described with reference to FIGS. 2A and 2B, according to an embodiment.

FIG. 3B illustrates configuration of a power policy using a display, according to an embodiment.

FIG. 4A is a flow chart illustrating a method for distributing available power between a plurality of cards hot pluggable into chassis slots, according to an embodiment.

FIG. 4B is a flow chart illustrating additional details for processing a triggering of a power policy described with reference to FIG. 4A, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements. Similarly, the functionality of various mechanical elements, members, and/or components for forming modules, sub-assemblies and assemblies assembled in accordance with a structure for an apparatus may be implemented using various materials and coupling techniques, depending on the application requirements.

As described earlier, traditional power allocation tools and techniques may often reserve power for a preset or fixed set of shared cards, regardless of whether they are being actually included in a server. Utilizing a power policy that is based on a preset or fixed set of shared cards often results in over-provisioning of power for the fixed set of shared cards, which may potentially limit a blade server or other component from receiving power when hot plugged. That is, many preset power allocation schemes may not assure server components such as a blade server that they would receive power when hot plugged. Thus, many traditional power allocation tools and techniques may degrade user experience. Therefore, a need exists for a method and system for a flexible and user configurable power policy to allocate available power. According to one embodiment, in a method and system for distributing available power between a plurality of cards hot pluggable into chassis slots, a power policy, which defines rules and conditions for assuredly distributing the available power to selected ones of the plurality of cards, is configured. The selected ones, each of which is assured to receive power when hot plugged, are selectable to include any card of the plurality of cards. When any one of the plurality of cards is hot plugged into one of the slots, the power policy is triggered to assuredly distribute the available power to the selected ones that are hot plugged, or activate an alarm if the any one card that is hot plugged is excluded from the selected ones. The power policy is modifiable in response to a change in the rules and conditions.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, the IHS may be a personal computer, including notebook computers, personal digital assistants, cellular phones, gaming consoles, a server, a network storage device, or any other suitable device and may vary in size, shape, performance, functionality, and price. The IHS may include random access memory (RAM), one or more processing resources such as central processing unit (CPU) or hardware or software control logic, read only memory (ROM), and/or other types of nonvolatile memory. Additional components of the IHS may include one or more disk drives, one or more network ports for communicating with external devices as well as various I/O devices, such as a keyboard, a mouse, and a video display. The IHS may also include one or more buses operable to receive/transmit communications between the various hardware components.

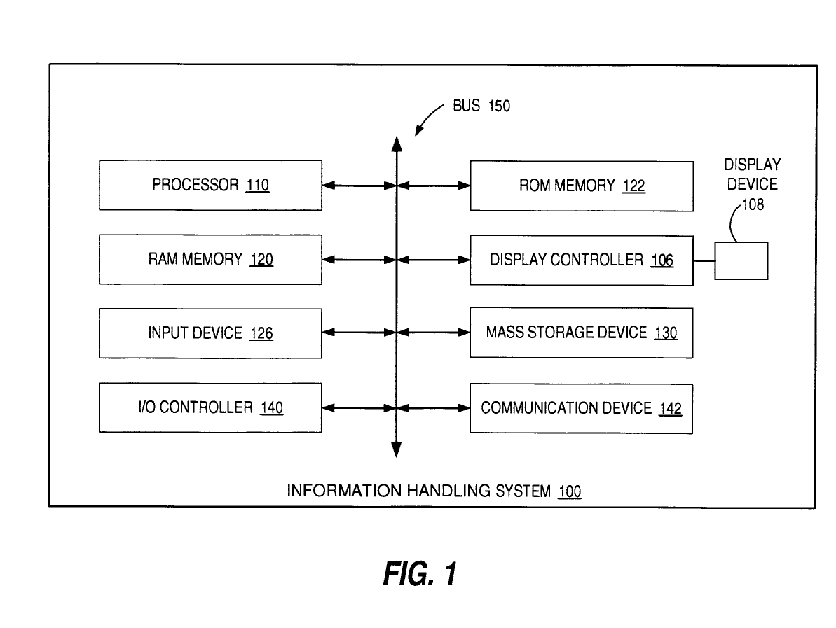

FIG. 1 illustrates a block diagram of an IHS 100, according to an embodiment. The IHS 100 includes a processor 110, which is coupled to a bus 150. The bus 150 serves as a connection between the processor 110 and other components of the IHS 100. An input device 126 is coupled to the processor 110 to provide input to the IHS 100. Examples of input devices may include keyboards, touchscreens, and pointing devices such as mouses, trackballs and trackpads. Software programs, including instructions, and data are stored on a mass storage device 130, which is coupled to processor 110 via the bus 150. Mass storage devices may include such devices as hard disks, optical disks, magneto-optical drives, floppy drives and the like. The IHS 100 further includes a display controller 106 to generate displays that are displayable on a display device 108, the display controller 106 being coupled to the processor 110 by the bus 150. A system memory 120, which may also be referred to as RAM or main memory, is coupled to the processor 110 to provide the processor with fast storage to facilitate execution of computer programs by the processor 110. Although the IHS 100 is shown to include one processor, e.g., the processor 110, additional processors may be included to process additional I/O.

In an exemplary, non-depicted embodiment, a chassis or a rack houses the main electronic components of the computer system, including a motherboard (also referred to as a planar module), power supply, cooling system, and optional cards, such as interface boards that provide audio, video and/or networking capabilities. It should be understood that other buses and intermediate circuits can be deployed between the components described above and processor 110 to facilitate interconnection between the components and the processor 110.

The IHS 100 may also include a non-volatile ROM 122 memory, an I/O controller 140 for controlling various other I/O devices. For example, the I/O controller 140 may include a serial and/or parallel I/O bus controller. It should be understood that the term “information handling system” is intended to encompass any device having a processor that executes instructions from a memory medium.

The IHS 100 is shown to include the mass storage device 130 connected to the processor 110, although some embodiments may not include the mass storage device 130. In a particular embodiment, the IHS 100 may include additional hard disks. The bus 150 may include data, address and control lines. In an exemplary, non-depicted embodiment, not all devices shown may be directly coupled to the bus 150. In one embodiment, the IHS 100 may include multiple instances of the bus 150. The multiple instances of the bus 150 may be in compliance with one or more proprietary standards and/or one or more industry standards such as peripheral component interconnect (PCI), PCI express (PCIe), industry standard architecture (ISA), universal serial bus (USB), system management bus (SMBus), and similar others. A communication device 142, such as a network interface card and/or a radio device, may be connected to the bus 150 to enable wired and/or wireless information exchange between the IHS 100 and other devices (not shown).

The processor 110 is operable to execute the instructions and/or operations of the IHS 100. The memory medium, e.g., RAM 120, preferably stores instructions (also known as a “software program”) for implementing various embodiments of a method in accordance with the present disclosure. An operating system (OS) of the IHS 100 is a type of software program that controls execution of other software programs, referred to as application software programs. In various embodiments the instructions and/or software programs may be implemented in various ways, including procedure-based techniques, component-based techniques, and/or object-oriented techniques, among others. Specific examples include assembler, C, XML, C++ objects, Java and Microsoft's .NET technology.

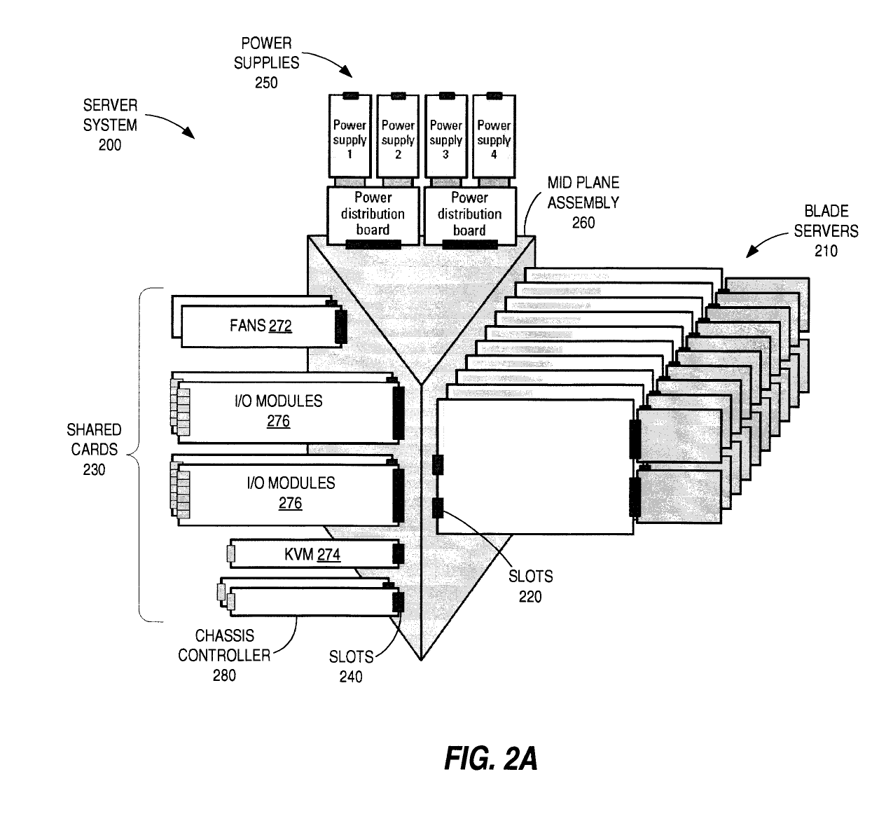

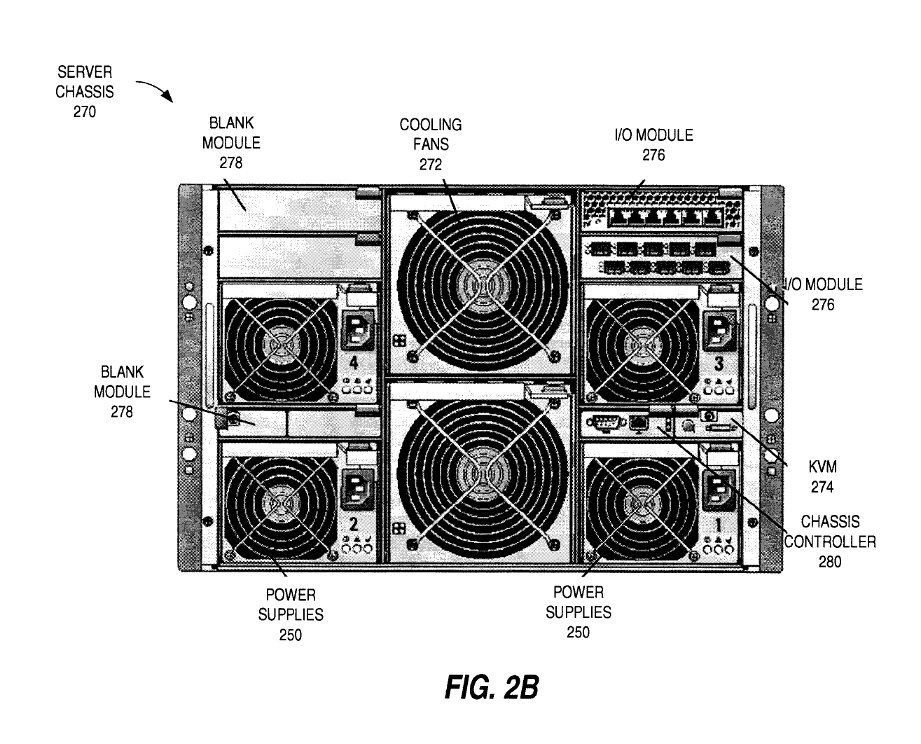

FIG. 2A illustrates a block diagram of a server system 200, according to an embodiment. FIG. 2B illustrates a rear view of a server chassis 270, according to an embodiment. Referring to FIGS. 2A and 2B, the server system 200 includes a plurality of cards, which include one or more blade servers 210 that are hot pluggable into slots 220, and one or more shared cards 230 that are hot pluggable into slots 240. The number of slots 220 and 240 may vary, e.g., between 1 and 32, depending on factors such as chassis size, desired server performance, and similar others. In an embodiment, each one of the plurality of cards includes a processor, and may be implemented using IHS 100 described with reference to FIG. 1. Also included in the server system 200 are power supplies 250 that provide power to the server components, and a mid plane assembly 260 that is passive, enables the distribution of the power, and enables communication between the blade servers 210 and the shared cards 230.

In an embodiment, the shared cards 230, and the power supplies 250 are shared components that are shared by the blade servers 210 for performing common functions such as I/O. In a particular embodiment, the shared components include the power supplies 250, cooling fans 272, I/O modules 276 (including I/O fabric cards), a chassis controller 280, and a keyboard, video, mouse (KVM) switch module 274. The shared components of the server system 200 advantageously reduce rack space, and reduce the number of power supplies, fans, rails, and cables required when compared to a traditional server. The shared components are accessible from the rear of the server chassis 270, as shown in FIG. 2B. In an exemplary, non-depicted embodiment, the blade servers 210 are accessible via the front of the server chassis 270. Empty slots may be filled with a blank module 278.

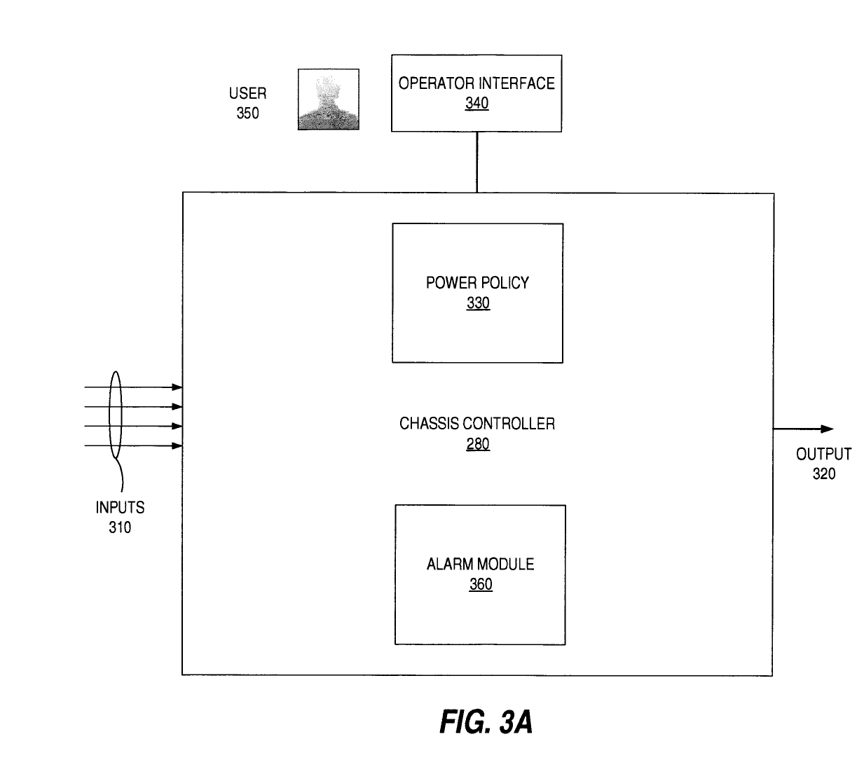

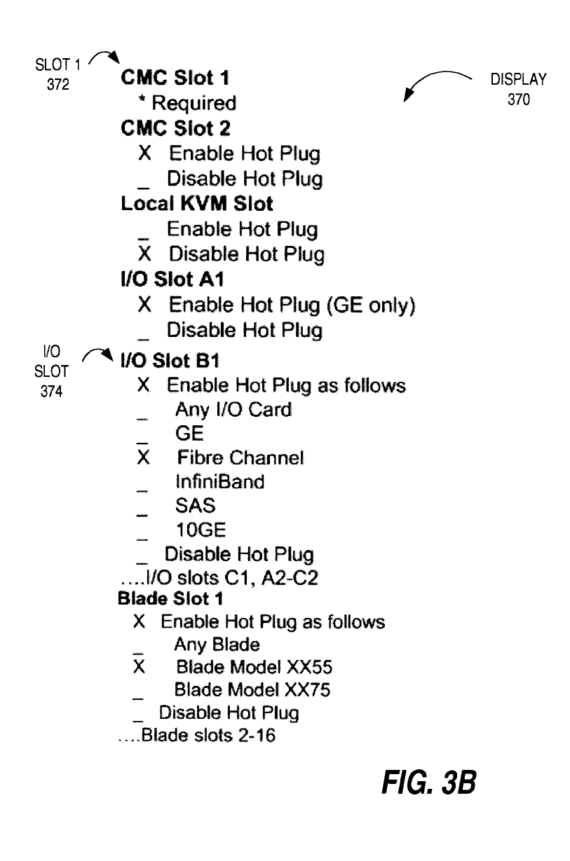

FIG. 3A illustrates a block diagram to show additional details of the chassis controller 280 described with reference to FIGS. 2A and 2B, according to an embodiment. In an embodiment, the chassis controller 280 receives inputs 310 that detect and monitor the presence, and health of all server components including the I/O modules 276, cooling fans 272, KVM switch module 274, power supplies 250, and the blade servers 210. The chassis controller 280 also includes a power policy 330, which may be implemented as hardware (e.g., logic circuits) or as a software program that is executable by a processor. As described earlier, the power policy 330 defines an algorithm or the functions and methods used to allocate power. The power policy 330 may include rules and conditions, which determine at least one output 320 based on the inputs 310 received by the chassis controller 280. The at least one output 320 is used to control the distribution of available power to a hot plugged card, e.g., enable or disable provisioning of power to a hot plugged card.

When triggered, the power policy 330 performs power allocation within the server system 200. The power policy 330 may be automatically activated at initial power on condition of the chassis controller 280. The power policy 330 may be re-evaluated, e.g., by evaluating power demand and supply, on a continuous basis or in response to an event such as hot plugging of a card, which generates the trigger. When the card is hot plugged in a slot, card identification circuits are powered, and the hot plugged card is automatically identified by the chassis controller 280. The power policy 330 decides whether to provide budgeted or requested power or not provide the budgeted or requested power to the hot plugged card. The decision is performed in real-time by the chassis controller 280. The power policy 330, which is used to arrive at the decision, is customizable for each server system during the configuration process.

In an embodiment, the chassis controller 280 interacts with a user 350 via an operator interface 340. The operator interface 340, which may be similar to the display device 108 described with reference to FIG. 1, provides a graphical user interface (GUI) for the user interaction. For example, the GUI may be in the form of a display used to initially configure the power policy 330 or to modify the initial configuration. Additional details of a display used for configuration is described with reference to FIG. 3B. The chassis controller 280 is operable to control the power distribution via the at least one output 320 by assuredly (e.g., in an assured manner) providing the power to selected ones of the plurality of cards, e.g., the server blades 210 and the shared cards 230.

During the configuration process, the selected ones of the plurality of cards are selectable to include any card or cards of the plurality of cards, provided the total power consumed by the selected ones does not exceed the available power. Any one of the selected ones of the plurality of cards is assured to receive the power when hot plugged into one of the slots by reserving power for the selected ones. Spare power that may be available to other cards is calculated by subtracting power reserved for the selected ones from the available power from the power supplies 250.

As described earlier, when the hot plugged card is identified by the chassis controller 280, the power policy 330 is used to determine whether the hot plugged card matches one of the selected ones. If there is a match, the chassis controller 280 enables the hot plugged card to power on, and receive the budgeted power. If there is no match, the power policy 330 may be configured to take alternative action, e.g., generate alarm, determine spare power, and similar others.

In an embodiment, the chassis controller 280 includes an alarm module 360 to generate an alarm if there is no match. That is, the chassis controller 280 detects a presence of another card that has not been configured as one of the selected ones, and hence may not be assured to receive the power. In response to detecting that the another card is excluded from the selected ones, the power policy 330 may include rules and conditions that perform one of the following actions: 1) alarm but not enable the another card to power on, 2) alarm and enable power on if spare power is available, and 3) alarm and auto launch the GUI for the user 350 to authorize the provision of the power to the another card. The power policy 330 thus advantageously safeguards the server system 200 from over-provisioning the available power, while assuredly providing power to the selected ones.

FIG. 3B illustrates configuration of the power policy 330 described with reference to FIG. 3A using a display 370, according to an embodiment. In a particular embodiment, the user 350 may select the selected ones of the plurality of cards by enabling or disabling the hot plug feature for each slot. Slots that are configured to be enabled for hot plug are automatically included in the selected ones, and power is reserved for these cards when hot plugged. Slots that are configured to be disabled for hot plug are excluded from the selected ones, and there is no assurance that power may be available for these cards when hot plugged. In a particular embodiment, the chassis controller 280 may have a dedicated slot, e.g., slot 1 372 and slot 2 for a redundant controller if present. The chassis controller 280 is always assured of being powered on when power is initially turned to the server system 200.

The user 350 may further customize the configuration by selecting one of several expected cards that may be inserted in the slots. For example, e.g., I/O slot B1 374, the user 350 may define 6 different card types that may be expected in that slot, select one I/O card for the slot 374, and reserve power for the selected ones of the plurality of cards to assure that power is available when hot plugged. If an unexpected card is hot plugged into a slot, then an alarm may be generated to notify the user 350.

The power policy 330 may be modified by re-defining properties of the slots or the cards via the display 370. The modification may include de-selecting a card that was previously included in the selected ones or selecting another card to be included in the selected ones, the another card being previously excluded from the selected ones. The power policy 330 may be modified as new technology becomes available. If a lower power I/O card is available, the power policy 330 may be modified to enable hot plugging of the lower power I/O card. In an embodiment, the power policy 330 may include rules and conditions that define a maximum amount of power consumed by each one of the slots, or define a maximum current allowable per card.

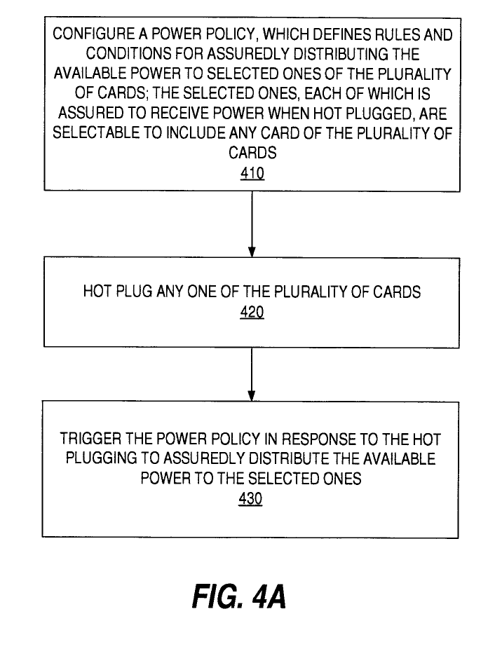

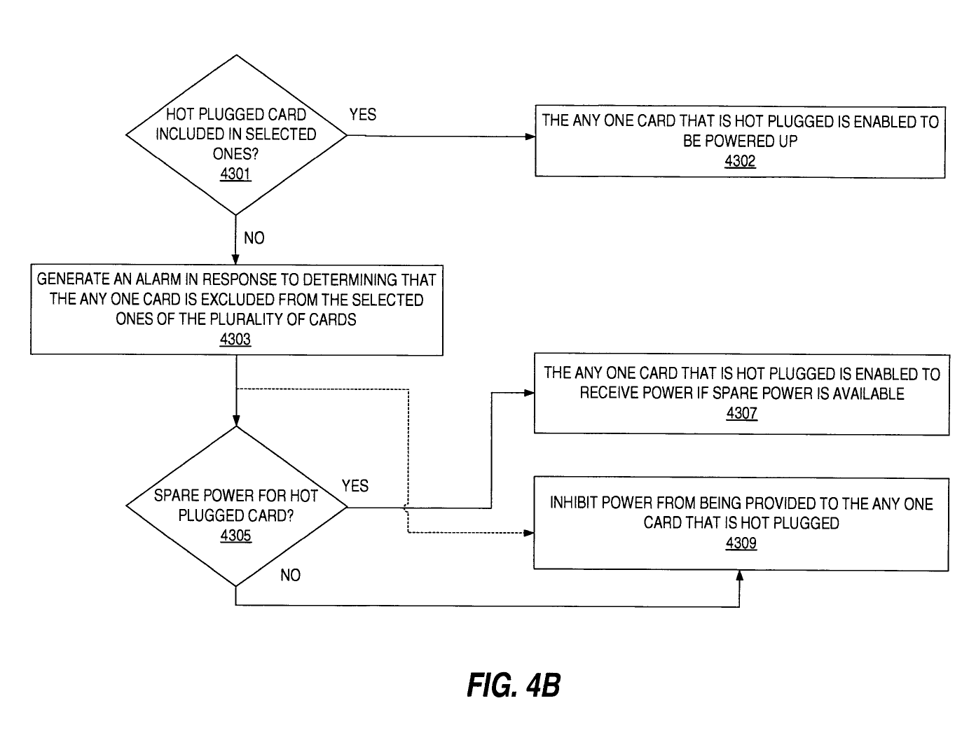

FIG. 4A is a flow chart illustrating a method for distributing available power between a plurality of cards hot pluggable into chassis slots, according to an embodiment. In a particular embodiment, the method may be used to distribute power in the server system 200 described with reference to FIGS. 2A, 2B, 3A and 3B. At step 410, a power policy, which defines rules and conditions for assuredly distributing the available power to selected ones of the plurality of cards, is configured. The selected ones, each of which is assured to receive power when hot plugged, are selectable to include any card of the plurality of cards. At step 420, any one of the plurality of cards is hot plugged. At step 430, the power policy is triggered in response to the hot plugging to assuredly distribute the available power to the selected ones.

Various steps described above may be added, omitted, combined, altered, or performed in different orders. For example, step 430 may include additional steps 4301, 4303, 4305, 4307 and 4309 illustrated in FIG. 4B, according to an embodiment. Referring to FIG. 4B, at step 4301, a determination is made whether the any one card that is hot plugged is included in the selected ones of the plurality of cards. If the determination is positive then the hot plugged card is enabled to be powered up at step 4302. At step 4303, an alarm is generated in response to the hot plugging if it is determined that the any one card is excluded from the selected ones of the plurality of cards. At step 4305, a determination is made whether spare power is available to power the any one card that is hot plugged. At step 4307, the any one card that is hot plugged is enabled to receive power if it is determined that spare power is available. At step 4309 power is inhibited from being provided to the any one card that is hot plugged if no spare power is available. As an option, steps 4305 and 4307 may be bypassed after the alarming performed at step 4303, and step 4309 may be performed after step 4303.

Several advantages are achieved by the method and system according to the illustrative embodiments presented herein. The embodiments advantageously provide an improved power policy or power allocation tools and techniques that are capable of reserving power for user selected ones of the hot pluggable cards. The rules and conditions for selecting the user selected ones of the hot pluggable cards may be advantageously configured, as well as modified, by the user. The improved power policy is thus advantageously customizable by the user to match desired server performance and availability. The user experience is improved by being assured that all user defined hot pluggable cards receive power when hot plugged. In addition, the user experience is also improved by being notified of an alarm condition, which may be generated if another card that is not one of the selected ones is hot plugged.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method for distributing available power between a plurality of cards that are hot pluggable into chassis slots, the method comprising:
configuring a power policy, wherein the power policy configuration includes defining rules and conditions for assuredly distributing the available power to selected ones of the plurality of cards, wherein the selected ones are selectable to include any card of the plurality of cards;
hot plugging any one card of the plurality of cards; and
triggering the power policy to assuredly distribute the available power to the selected ones that are hot plugged.

2. The method of claim 1, wherein the triggering includes:
determining whether the any one card that is hot plugged is included in the selected ones of the plurality of cards;
alarming the hot plugging if the any one card is excluded from the selected ones;
determining whether spare power is available to power the any one card; and
enabling the any one card to receive the spare power.

3. The method of claim 2, wherein the spare power is determined by subtracting reserved power allocated to assuredly power the selected ones from the available power.

4. The method of claim 2 further comprising:
inhibiting the power from being provided to the any one card in response to the alarming.

5. The method of claim 1, wherein the power policy is modifiable in response to a change in the rules and conditions.

6. The method of claim 5, wherein the change includes de-selecting a card that was previously included in the selected ones or selecting another card to be included in the selected ones, the another card being previously excluded from the selected ones.

7. The method of claim 1, wherein the rules and conditions define a maximum amount of power consumed by each one of the slots.

8. The method of claim 1, wherein the rules and conditions define whether each one of the plurality of cards is enabled or disabled for the hot plugging, wherein the selected ones of the plurality of cards are enabled for the hot plugging.

9. The method of claim 8, wherein each one of the selected ones of the plurality of cards that are enabled have a reserved power allocation that is subtracted from the available power.

10. The method of claim 1, wherein the rules and conditions define the power consumed by each one of the plurality of cards.

11. The method of claim 1, wherein the selected ones of the plurality of cards include a chassis controller, a keyboard, video, mouse (KVM) card, an input/output (I/O) card, a cooling fan card, and a blade server.

12. A server comprising:
a plurality of cards;
a chassis having slots, wherein the plurality of cards are hot pluggable into the slots;
a power supply operable to provide power to the plurality of cards;
a backplane to distribute the power and enable communication between the plurality of cards; and
a chassis controller that is hot pluggable into the slots, wherein the chassis controller is operable to control the power by assuredly providing the power to selected ones of the plurality of cards, wherein the selected ones are selectable to include any card of the plurality of cards, wherein any one of the selected ones is assured to receive the power when hot plugged into one of the slots.

13. The server of claim 12, wherein the chassis controller includes an alarm module operable to activate an alarm when another card that is excluded from the selected ones is hot plugged into the slots.

14. The server of claim 13, wherein the chassis controller is operable to inhibit the power from being provided to the another card in response to the alarm.

15. The server of claim 13, wherein the chassis controller is operable to determine availability of spare power, wherein the chassis controller is operable to enable the another card to receive the spare power if available.

16. The server of claim 12, wherein the selected ones of the plurality of cards include a chassis controller, a KVM card, an I/O card, a cooling fan card, and a blade server.

17. An information handling system (IHS) comprising:
a chassis having a backplane and a plurality of slots;
a plurality of cards coupled to the backplane, wherein the plurality of cards are hot pluggable into a corresponding one of the plurality of slots, wherein each one of the plurality of cards includes a processor; and
a power supply to provide power to the plurality of cards, wherein a flow of the power is controlled by one of the processor by assuredly providing the power to selected ones of the plurality of cards in response to hot plugging any one of selected ones into one of the plurality of slots, wherein the selected ones are selectable to include any card of the plurality of cards.

18. The IHS of claim 17, wherein the processor is operable to activate an alarm when another card that is excluded from the selected ones is hot plugged into the slots.

19. The IHS of claim 18, wherein the processor is operable to inhibit the power from being provided to the another card in response to the alarm.

20. The IHS of claim 17, wherein the selected ones of the plurality of cards include a chassis controller, a KVM card, an I/O card, a cooling fan card, and a blade server.
